(19) United States
(12) Patent Application Publication
(10) Pub. No.: US 2012/0126531 A1
(43) Pub. Date: May 24, 2012

(54) SHIELD ASSEMBLY FOR GARDEN HOSE CONNECTING ENDS

(76) Inventor: Kevin John Koskie, Green Bay, WI (US)

(21) Appl. No.: 13/299,590

(22) Filed: Nov. 18, 2011

Related U.S. Application Data
(60) Provisional application No. 61/416,144, filed on Nov. 22, 2010.

(51) Int. Cl. F16L 11/12

(52) U.S. Cl. 285/45

(57) ABSTRACT

A shield assembly for protecting garden hose connecting ends is disclosed. The shield is adapted to slide over an inner sleeve attached to the hose end. Several mechanism embodiments are provided for preventing the free longitudinal and radial movements of the shield relative to the inner sleeve and for securing the shield in multiple positions to accommodate various lengths of hose connecting ends. An embodiment for a split shield and inner sleeve that allows installation onto an existing hose is also disclosed.

### RELATED APPLICATIONS

This application claims priority from provisional application No. 61/416,144 filed on Nov. 22, 2010.

### FIELD OF THE INVENTION

The present invention relates to a shield for protecting garden hose connecting ends from damage. Such damage may result from ordinary wear-and-tear and from wheels of vehicles or foot traffic that may crush the hose connecting ends while in use and not readily visible.

### BACKGROUND OF THE INVENTION

The male connector end of garden hoses used for landscaping, irrigation or sprinkling vegetation are exposed to rough treatment as they are dragged across concrete and uneven terrain, or crushed under the tires of utility vehicles or implements that accidentally drive over them, damaging the male threading and compromising the attachment of nozzles, sprayers and other apparatus. These threaded ends are typically made of a soft metal, such as brass, and may therefore be susceptible to damage, especially if they are not readily visible to drivers. Malfunction and leakage renders the male threading useless. In addition, industrial landscapers and hardscapers use hoses that often extend tens to sometimes hundreds of feet into the areas that require watering. These hoses typically contain one or more sections connected to each other by threading male and female connector ends, which increases the exposure to damage as construction vehicles move through building sites. As can be seen, there is a need for a shield that protects the soft metal threadings of hoses from the possibility of damage. The prior art references present a multitude of embodiments to deal with this problem. US 2009/0050230 relates to a protector device for the ends of the tubular goods, such as tubes for the oil industry, OCTG, line pipes and the like. The protector device may include two pieces, a generally elongate protector body and a bumper reinforcement that may be reversibly connected to the protector body.

U.S. Pat. No. 7,404,419 discloses a protector for the ends of tubular elements which comprises: a ring made from a deformable material, wherein the external surface of one of the ends thereof has a conical thread; and a threaded cap made from a deformable material, which comprises a closed end and an open end wherein the internal surface of said open end includes a conical thread which matches that of the external end of ring.

US 2008/0222843 teaches a two-part protector for a pipe end provided with an external thread or internal thread having a substantially cylindrical thread part of plastic material that covers the thread of the pipe end and further has a sleeve of metal that is also substantially cylindrical and supports the threaded part rearwardly. The threaded part and the sleeve engage one another securingly by securing projections and securing cutouts.

U.S. Pat. No. 7,469,721 provides a thread protector for protecting threads of a pipe which includes a body having female or male threads shaped for threaded engagement with male or female threads formed on a pin or box end of a pipe. An elastically flexible annular sealing projection extends from the body to a location where it will be elastically flexed by and in line contact with an end surface of the pipe when the threads of the protector are engaged with the threads of the pipe.

U.S. Pat. No. 5,333,650 describes a hose coupling for being attached to one end of a hose comprising a coupling portion for joining the hose coupling to another mateable coupling, and a generally tubular sleeve portion extending rearward from the coupling portion along the outer wall surface of the hose to discourage bending of the hose along a predetermined distance adjacent to the coupling portion.

U.S. Pat. No. 5,367,925 is for an anti-crimp wrench for a flexible garden hose wherein the anti-crimp wrench has a longitudinally extending ferrule sleeve body portion further having a cap engageable with a garden hose coupling attachable to the end of the garden hose.

Embodiments of U.S. Pat. No. 5,816,622 relate to a protective sleeve for a garden hose includes a protective shell section having a generally tubular body with an inner bore shaped for receiving a coupling of the garden hose snugly therein. A flexible strain relief section is releasably attached to the shell section wherein the flexible strain relief section has a generally tubular body.

While the relevant prior art embodiments generally solve the problem of protecting garden hoses from damage, the protecting devices represented in these embodiments tend to be placed in fixed and/or permanent positions and are therefore inflexible and/or non-reusable.

### SUMMARY OF THE PRESENT INVENTION

Embodiments of the present invention provide a shield assembly installed onto a garden hose that has the male connecting end. The shield is configured to protect both the male hose end connectors as well as the associated female connector end of a second garden hose section that may be connected to the first garden hose section. The shield may be placed in fixed positions and adapted to manually move from one fixed position to another.

In an aspect of the present invention, a shield assembly for garden hose connecting ends, the connecting ends containing a threaded male adaptor, the threaded male adaptor being joined with a ferrule member and a hose connector end portion, the connecting ends optionally comprising a female threaded member configured to being joined with the threaded male adaptor, the shield assembly comprises: an inner sleeve adapted for encasing the hose connector end portion, the inner sleeve being attached to the hose connector end portion in a fixed and immobile position, the inner sleeve having a circular bore and a multisided outer wall surface, the outer wall surface containing at least four sides; an outer sleeve containing a sliding portion adapted for slidingly threading over the inner sleeve and an enlarged portion adapted to cover the hose connecting end, the sliding portion having a multisided inner wall surface, the multisided inner wall surface being adapted to match and fit over the multisided outer wall surface of the inner sleeve; and a mechanism for preventing an unintentional longitudinal sliding of the outer sleeve on the inner sleeve and for securing the outer sleeve in predetermined discreet positions.

In another aspect of the present invention, a shield assembly for garden hose connecting ends, the connecting ends containing a threaded male adaptor, the threaded male adaptor being joined with a ferrule member and a hose connector end portion, the connecting ends optionally comprising a female threaded member configured to being joined with the threaded male adaptor the shield assembly comprises: an inner sleeve adapted for encasing the hose connector end portion, the base sleeve being attached to the hose connector end portion in a fixed and immobile position, the inner sleeve having a circular bore, a front end and a circular outer wall surface; an outer sleeve containing a sliding portion adapted for slidingly threading over the inner sleeve and an enlarged portion adapted to cover the hose connecting end, the sliding portion having a substantially circular inner wall surface, the circular inner wall surface being adapted to match and fit over the circular outer wall surface of the inner sleeve; a mechanism for affixing the outer sleeve in an engage position; and a mechanism for affixing the outer sleeve in a disengage position.

These and other features, aspects and advantages of the present invention will become better understood with reference to the following drawings, descriptions and claims.

### BRIEF DESCRIPTION OF THE DRAWINGS

FIG. 1 is a side view of a hose connector end shield assembly according to a first embodiment of the present invention;

FIG. 2 is a side cutaway cross sectional view of a hose connector end shield assembly according to the first embodiment of the present invention;

FIG. 3 is another side cutaway cross sectional view of a hose connector end shield assembly according to the first embodiment of the present invention;

FIG. 4 is a front view of a hose connector end shield assembly according to the first embodiment of the present invention;

FIG. 5 is a front view of a component of the hose connector end shield assembly according to the first embodiment of the present invention;

FIG. 6 is a rear view of a hose connector end shield assembly according to the first embodiment of the present invention;

FIG. 7 is an exploded view showing specific components of the hose connector end shield assembly according to the first embodiment of the present invention;

FIG. 8 is a front view of a hose connector end shield assembly according to a second embodiment of the present invention;

FIG. 9 is a front view of a component of a hose connector end shield assembly according to a third embodiment of the present invention;

FIGS. 10 and 11 illustrate front views of assembled components of a hose connector end shield assembly according to the first embodiment of the present invention;

FIG. 12 shows a side exploded view of a hose connector end shield assembly according to the first embodiment of the present invention;

FIG. 13 is a side cutaway cross sectional view of a component of the hose connector end shield assembly according to the first embodiment of the present invention;

FIG. 14 is a side exploded view of a hose connector end shield assembly according to a fourth embodiment of the present invention;

FIG. 15 portrays a front view of a hose connector end shield assembly according to a fifth embodiment of the present invention;

FIG. 16 is a front view of a component of a hose connector end shield assembly according to a sixth embodiment of the present invention;

FIG. 17 is a side exploded view of a hose connector end shield assembly according to the fifth embodiment of the present invention;

FIG. 17A is component of the hose connector end shield assembly according to the fifth embodiment of the present invention;

FIG. 18 is a side cutaway cross sectional view of a hose connector end shield assembly according to the fourth embodiment of the present invention; and

FIG. 19 is a side cutaway cross sectional view of a hose connector end shield assembly according to the fifth embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention provides an assembly for shielding garden hose connecting ends from damage. It is desirable for the assembly to be in position to protect the garden hose connecting ends when the ends are placed in the path of vehicles such as lawn mowers, cars or trucks, or in areas where walkers could accidentally step on the connecting ends and damage them. However, it would also be desirable to move the shield away from the ends of the hose sections to allow connecting the ends as needed as well as having the ability to protect the female connectors of a second garden hose section that may be connected to the first section. Ideally, a mechanism would be available for placing and securing the shield in discreet positions in such a way as to accommodate and protect various lengths of the connecting ends of two hose sections that are connected to each other as needed and in a manner as to prevent the unintentional longitudinal and radial movement of the shield.

It would be further desirable to configure the assembly such that it may be mounted on an existing hose as well affixing the assembly on the hose in the hose manufacturing process.

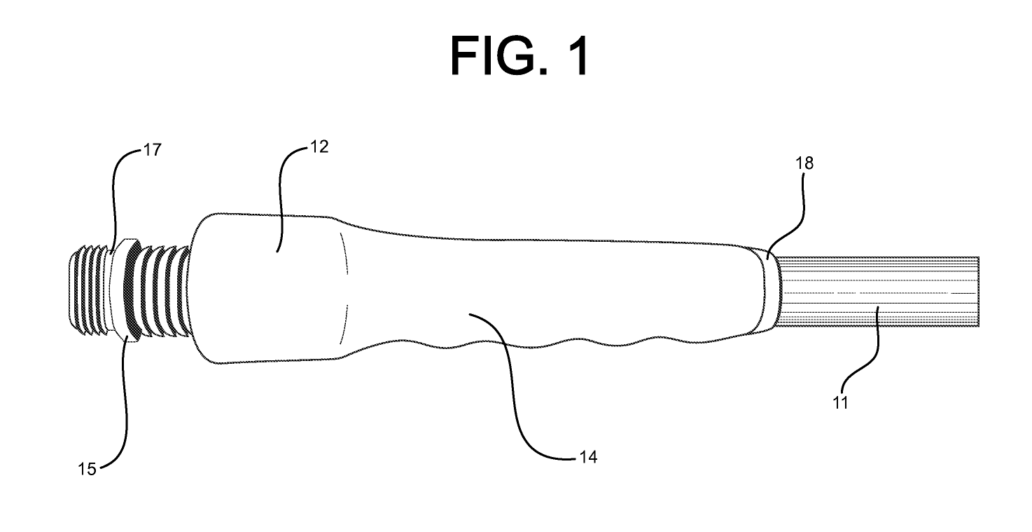

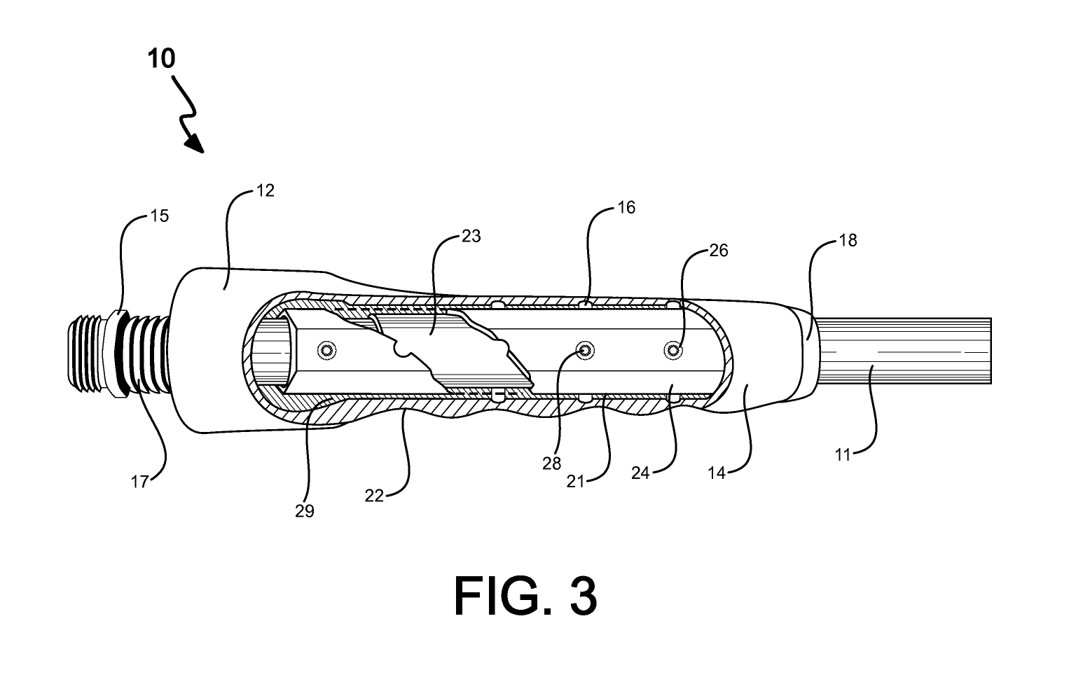

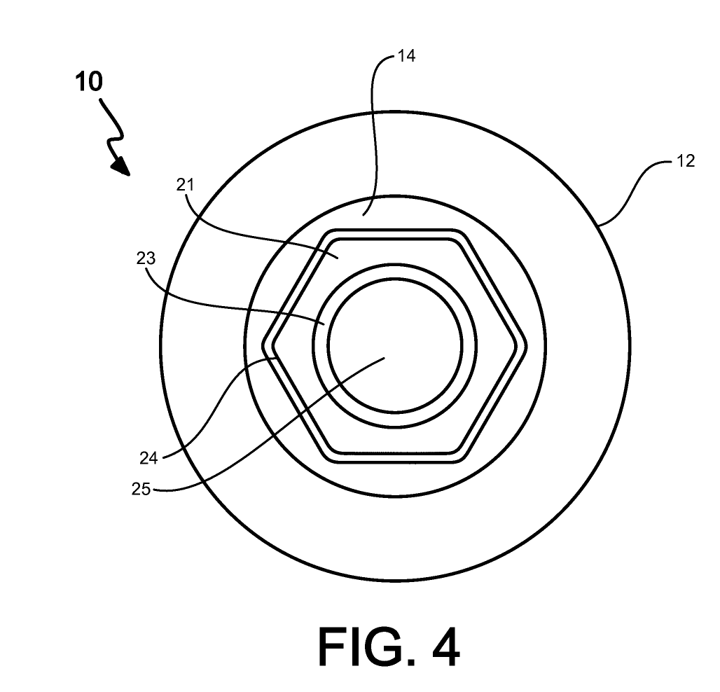

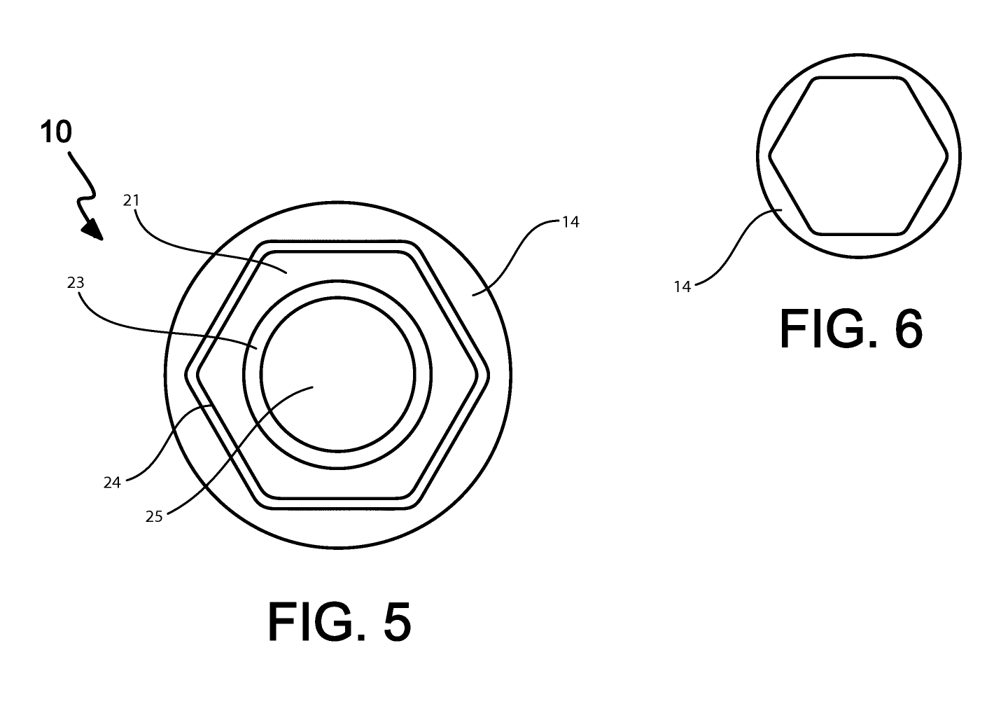

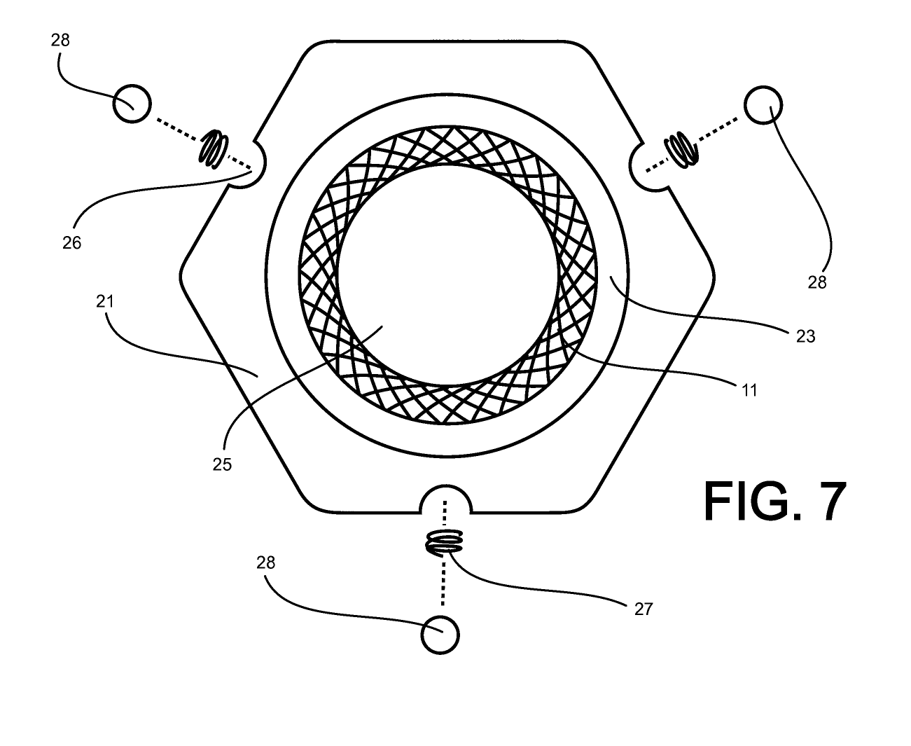

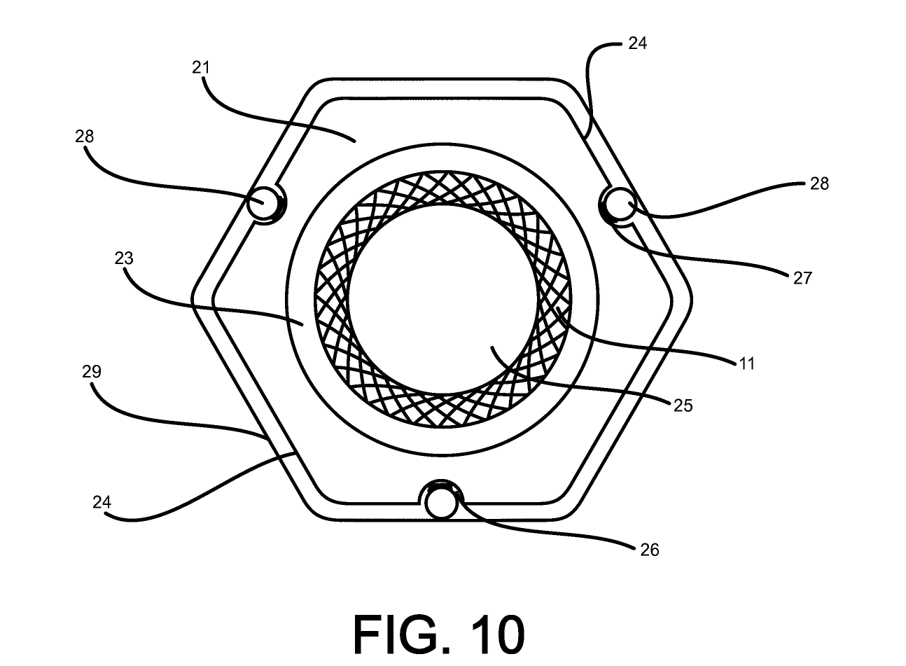

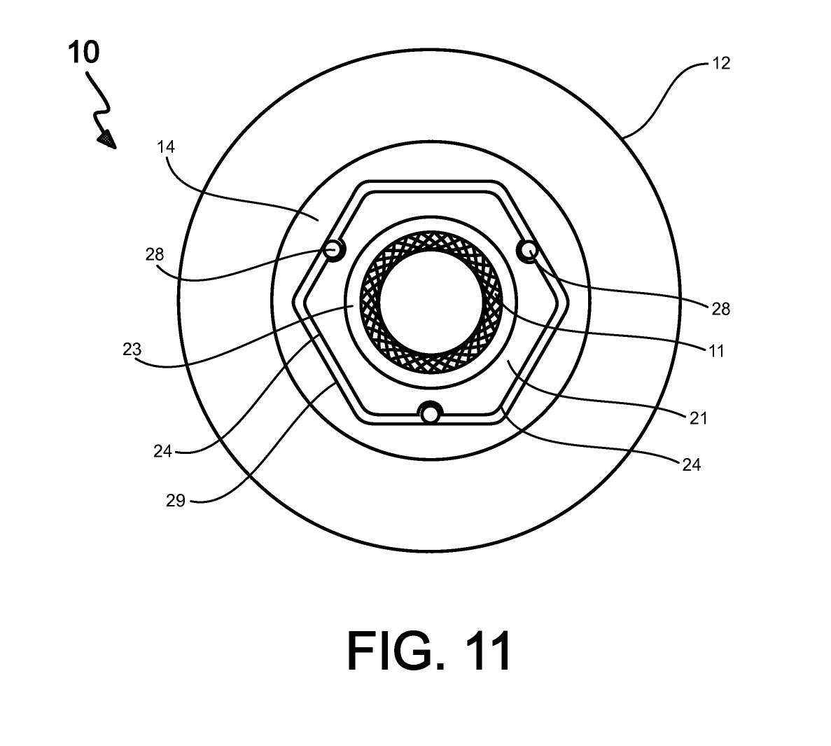

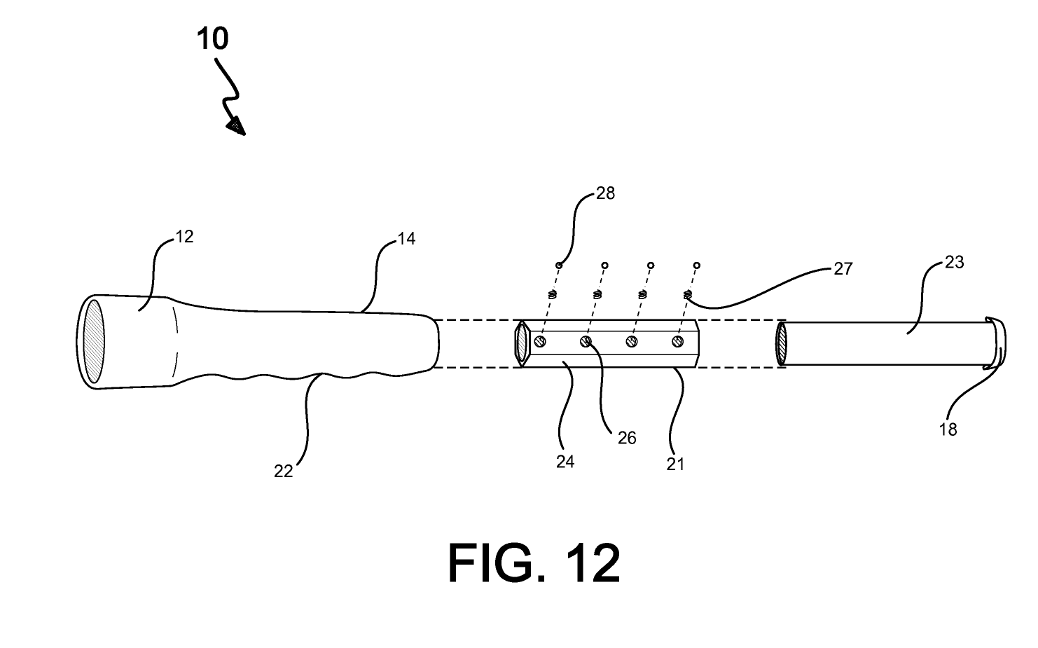

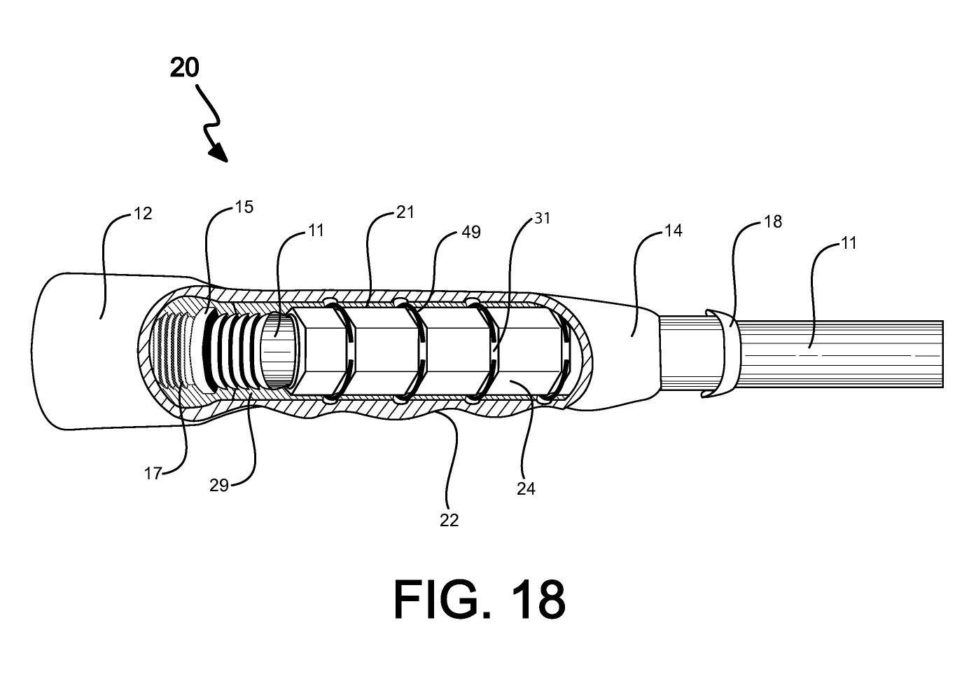

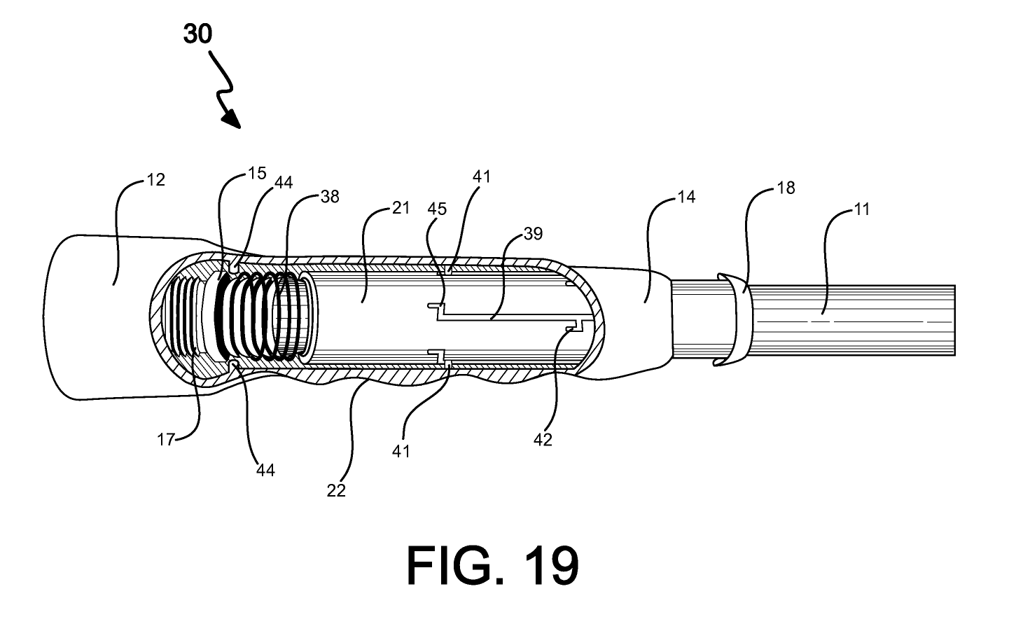

The embodiments of the present invention are illustrated in FIGS. 1-19. Embodiments of the present invention shield assembly are configured to protect a ferrule 15, i.e., a metal sleeve that joins a connector end portion of a hose 11 having an internal circular bore 25. The ferrule 15 contains the threaded male connector end 17 which may be threaded into the female counterpart of another hose. The ferrule contains a ring member as indicated by 15.

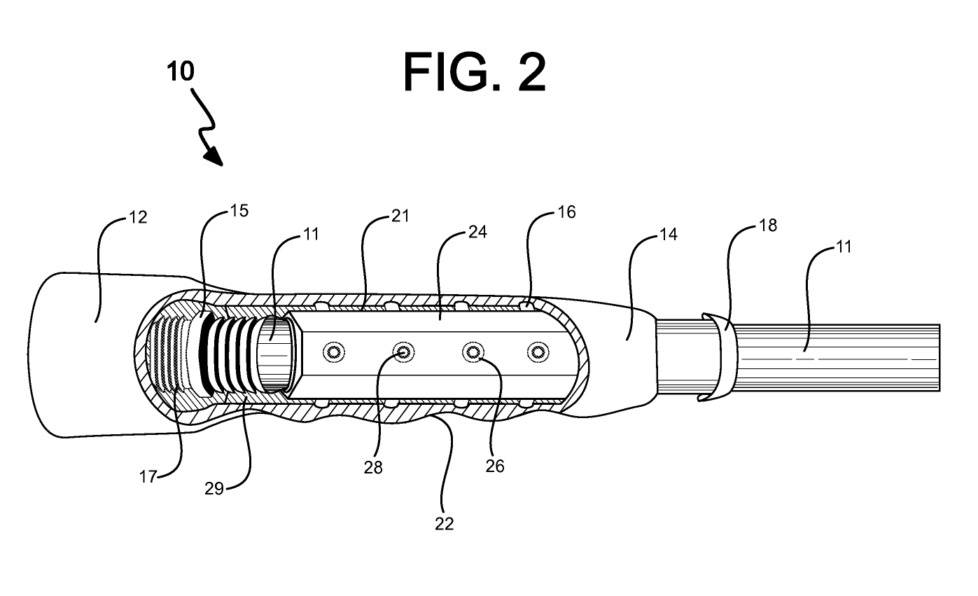

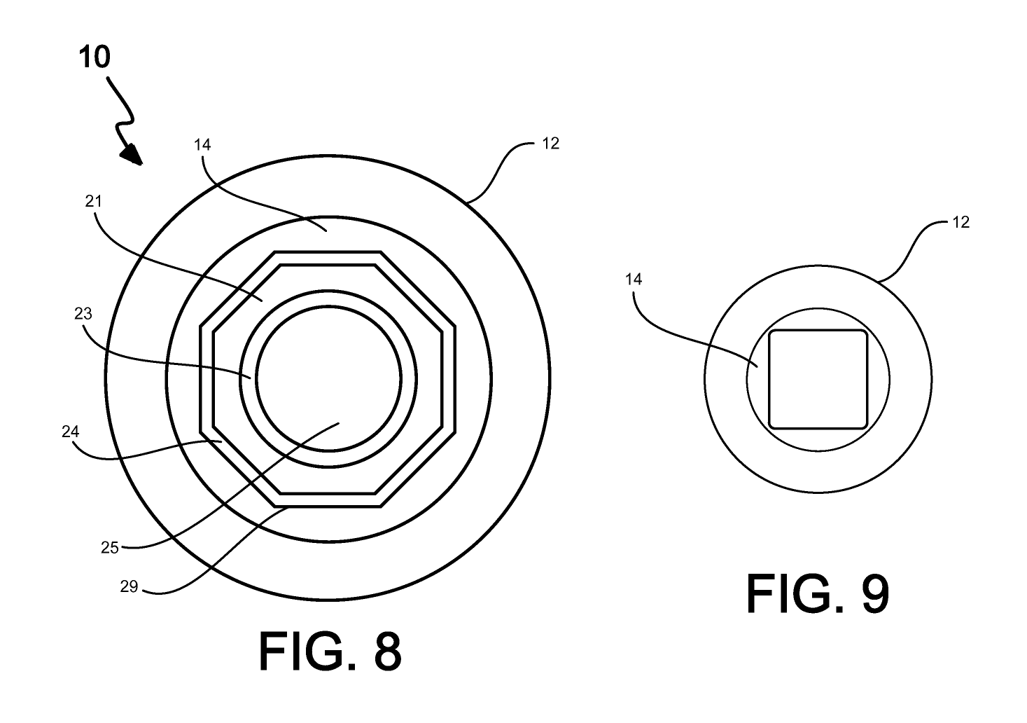

The first embodiment for the shield assembly 10 illustrated in FIGS. 1-7 and 10-13 comprises an outer sleeve 14, an inner sleeve 21 and optionally a cylindrical base sleeve 23. The base sleeve 23 is adapted to thread and tightly fit onto the connector end portion of the hose 11. The base sleeve 23 must be immobile and gluing to the connector end portion of the hose 11 is therefore desirable Inner sleeve 21 has a circular inner bore and is configured to thread and tightly fit onto the base sleeve 23. Outer sleeve 14 is configured to thread over and to longitudinally slide on inner sleeve 21. The inner surface 29 of the outer sleeve 14 and the outer surface 24 of the inner sleeve 21 have multisided shapes, preferably containing 4, six or eight sides. These surface shapes prevent the accidental radial movement of the outer sleeve 14 relative to the inner sleeve 21. Hexagonal shapes for the inner surface 29 of the outer sleeve 14 and outer surface 24 of the inner sleeve 21 are portrayed in FIGS. 2 to 7 and 10-14, while an octagonal shape is shown in FIG. 8 as a second embodiment and a square shape is shown in FIG. 9 as a third embodiment.

The front end 12 of the outer sleeve 14 is enlarged such that it fits over the male connecting end of the hose or male and female connecting ends that are joined with each other through their respective connecting ends and configured to shield the ends against damage. A stopper ring 18 may be attached to the back end of the base sleeve 23. The stopper ring 18 prevents the outer sleeve 14 from sliding too far to the rear. In an alternate embodiment of the present invention, no base sleeve 23 is used, the inner sleeve 21 is directly attached to the connector end portion of the hose 11 and the stopper ring 18 is attached to the back end of the inner sleeve 21. The outer surface of the outer sleeve 14 has a contoured area 22 for comfortable hand gripping.

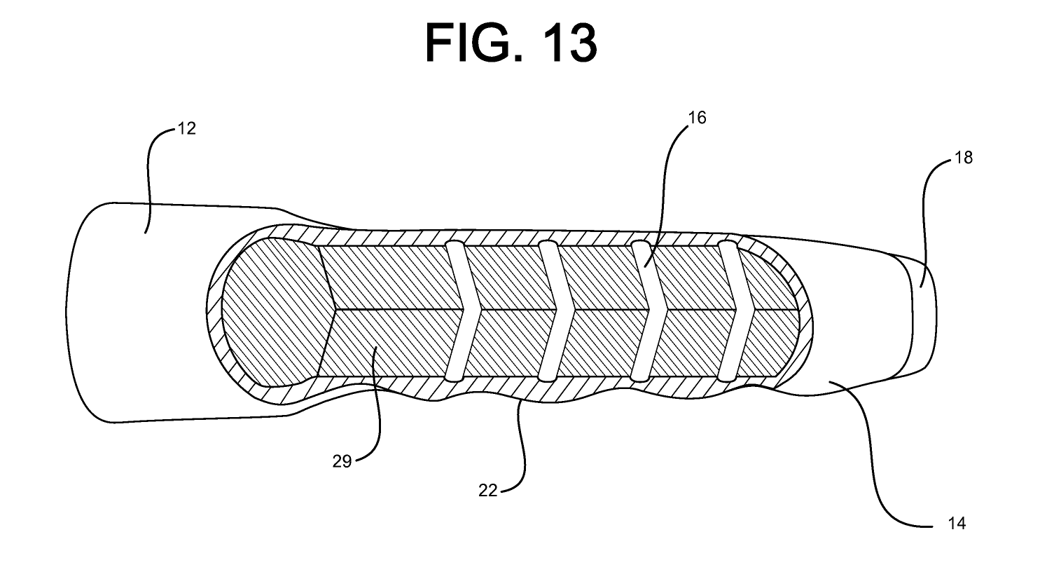

A mechanism for restricting the ease of sliding of the outer sleeve 14 against the inner sleeve 21 and for securing the longitudinal position of the outer sleeve 14 is incorporated in the present invention. In one embodiment, balls 28 are inserted into depressions 26 placed on the outer surfaces 24 of the inner sleeve 21 in such a way that they compress spring coil 27 disposed on the bottoms of each depression and in such a way that the balls 28 protrude outside the inner sleeve 21 outer surfaces 24. At least two and preferably four such depressions 26 are placed along alternate sides of the inner sleeve surfaces. Thus, for hexagonal shape surfaces, four depressions 26 may be placed along each of three of the inner sleeve 21 surfaces 24 as shown in FIGS. 2, 7 and 10. The protruding spring loaded spheres 28 apply pressure on the inner surfaces 29 of the outer sleeve to restrict the outer sleeve from longitudinal free sliding. Four channels 16 are circumferentially placed along on the inner surface 29 of the outer sleeve 14 as shown in FIG. 13. Balls 28 are configured to protrude out of the inner sleeve 21 outer surface 24 into the inside the channels 16 causing the outer sleeve 14 to be substantially immobile in such a position excepting the use of some force to slide the outer sleeve 14 out of that position.

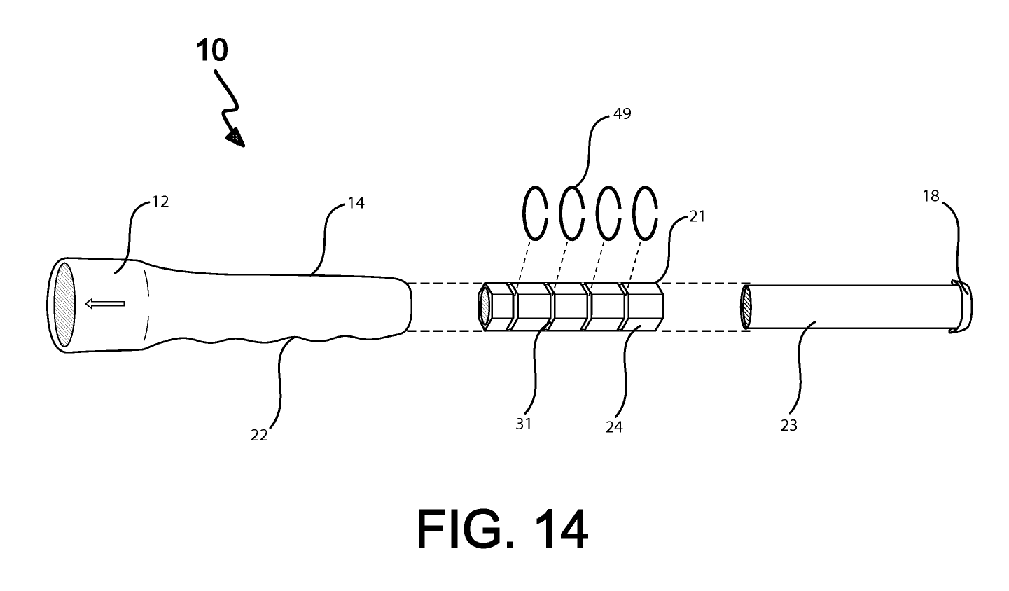

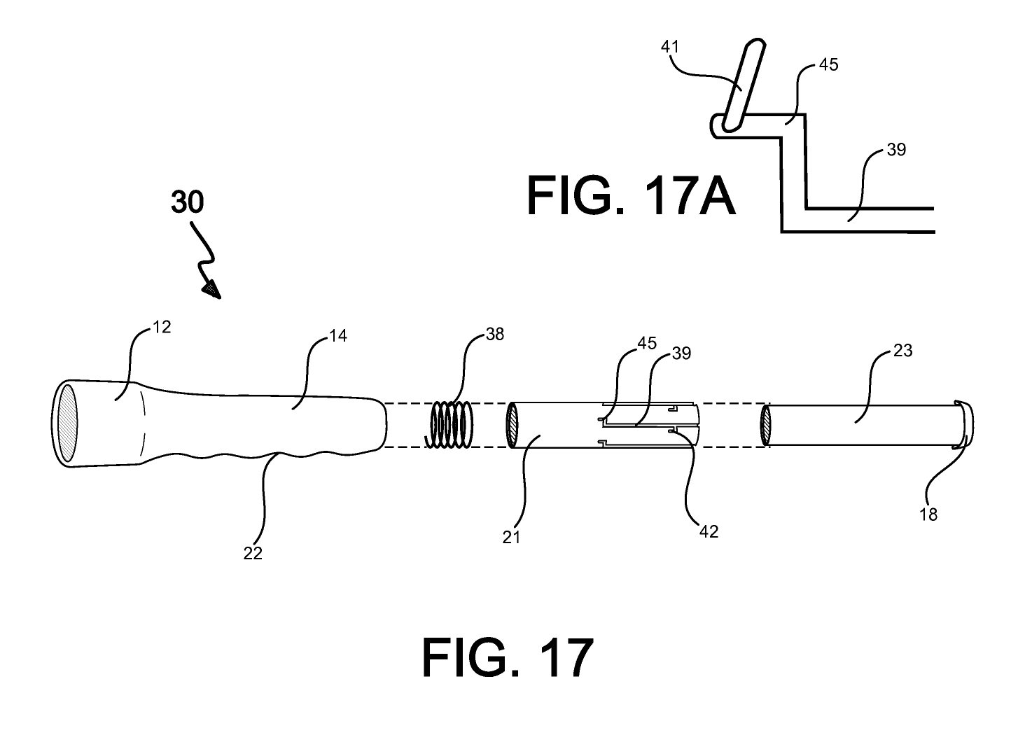

FIGS. 14 and 17 show another embodiment for a mechanism for restricting the ease of sliding of the outer sleeve 14 against the inner sleeve 21 and for substantially immobilizing the outer sleeve 14 in predetermined positions. Grooves 31 are placed circumferentially along the outer surface 24 of the inner sleeve 21. Compression rings 49 are placed inside the grooves 31 in a compressed form such that they exert pressure onto the inner surfaces 29 of the outer sleeve 14 thereby restricting the ease of sliding of the outer sleeve 14 against the inner sleeve 21. Further, the compression rings are adapted to fit inside the channels 16 causing the outer sleeve 14 to be substantially immobile in such a position excepting the use of some force to slide the outer sleeve 14 out of that position. This is designated as the fourth embodiment of the present invention for a shield assembly 20.

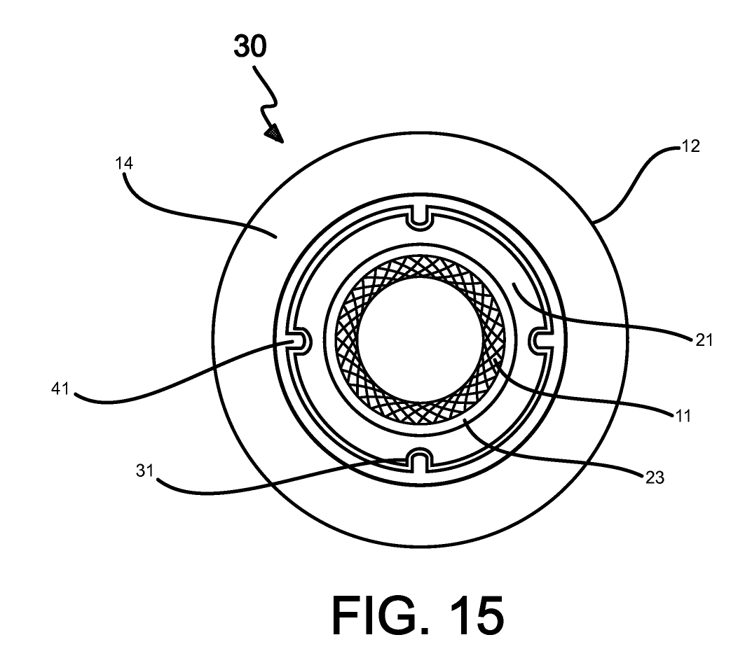

In a fifth embodiment for a shield assembly 30, the inner sleeve 21, outer surface 24 and the outer sleeve 14 inner surface have circular shapes. A channel system comprises three to five channels each having a longitudinal portion 39 and branched portions 45 are placed on the outer surface 24 of the inner sleeve 21 as shown in FIGS. 15, 17 and 19. Tabs 41 attached to the inner surface 29 of the outer sleeve 14 are adapted to fit inside channels 39 and 45. In the preferred embodiment, the longitudinal portions 39 and branched portions 45 of the channel system are equally spaced. Tensioning spring coil 38 is placed between the front end of the inner sleeve 21 and tabs 44 attached to the inner surface 29 of the outer sleeve 14 in such a way that the compression and decompression of the tensioning spring coil 38 is limited to between the front end of the inner sleeve 21 and tabs 44. At least two tabs and preferably three tabs 44 evenly spaced along the circumference of the outer sleeve 14 inner surface 29 are used. The branched portions of the channels 45 have a radial branch followed by a longitudinal branch and optionally a second radial branch; however multiple sets of a longitudinal branch followed by a radial branch also fall within the scope of the present invention. In the preferred embodiment, two branches are used: a branch 45 for locking the outer sleeve 14 in an engaged position in which the outer sleeve 14 covers the threaded male connector end 17 of the end portion of the hose 11, and a branch 42 for locking the outer sleeve 14 in a disengaged position in which the outer sleeve 14 is pulled back from the threaded male connector end 17 of the end portion of the hose 11. Branch 45 and branch 42 may have an “L” shape as shown in FIG. 17A; however other branch shapes may be used for the engaged and disengaged positions.

In order to secure the outer sleeve 14 in the engaged position, the outer sleeve 14 is moved toward the connector end portion of the hose 11 threaded male connector end 17 as tabs 41 slide inside their respective longitudinal channels 39. As the tabs 41 reach the branched channel members 45, the outer sleeve 14 is twisted radially to move the tabs 41 into the branched channel members 45. In this position, the outer sleeve 14 remains engaged, and disengaging the outer sleeve 14 requires a deliberate action by the user to move the tabs 41 of the outer sleeve 14 back into the longitudinal channels 39. In order to secure the outer sleeve 14 in the disengage position, the tabs 41 are moved along longitudinal channels 39 and into branched channel members 42. This requires pulling the outer sleeve 14 toward the back all the while compressing tensioning spring coil 38 as tabs 44 attached to the inner surface 29 of the outer sleeve 14 pushes the tensioning spring coil 38 against the front end of the inner sleeve 21. Thus, securing the outer sleeve 14 in the disengage position requires a deliberate action of pulling the outer sleeve 14 against the tensioning forces of the tensioning spring coil 38. This configuration helps assure that the default position of the outer sleeve 14 is the engaged position.

The aforementioned embodiments for a shield assembly for a threaded male connector end 17 represented in FIGS. 1-15 and 17-19 are only configured for installation onto the hose ends in the hose manufacturing process as the clearances are too tight for installing the one-piece sleeves onto an existing hose that contains the threaded male connector end 17. Thus, if the hose is damaged or otherwise worn out, any of the shield assembly embodiments described above that may be attached to it are rendered useless. It would be therefore desirable to have a shield assembly configured for installation on an existing hose in order, for example, to replace a damaged male hose connecting end or for reusing the shield assembly if the hose has worn out.

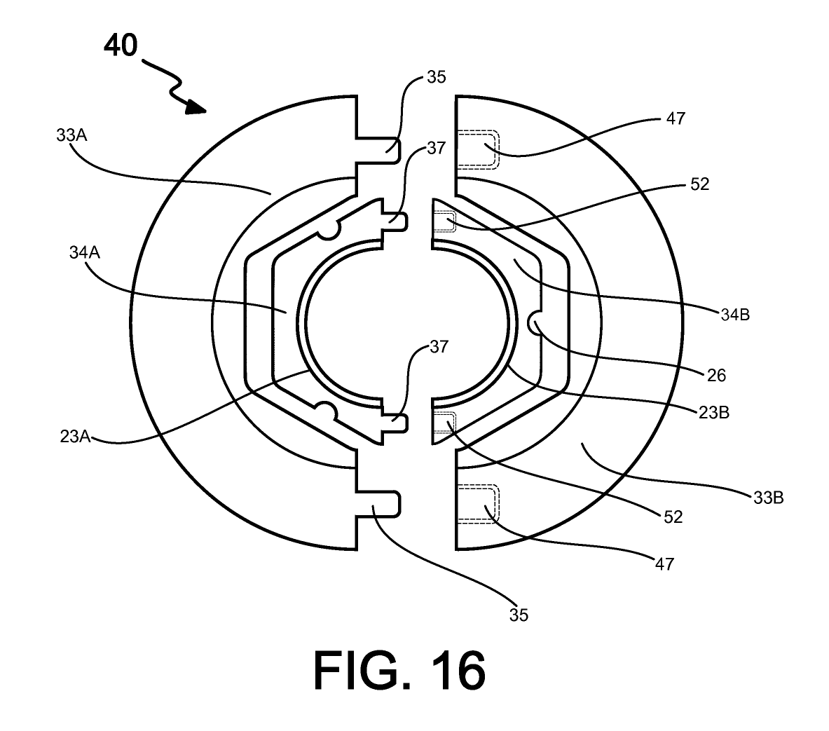

FIG. 16 illustrates an embodiment of a split shield assembly 40 that may be installed onto an existing hose end 11 containing the threaded male connector end 17. The outer sleeve, the inner sleeve and the base sleeve are each split into two preferably equal parts. The outer sleeve is split into a first member 33A and a second member 33B, the inner sleeve is split into first member 34A and second member 34B and the base sleeve is split between first member 23A and 23B. The first members and respective second members of each of the sleeves are combinable to form an integral assembly. The outer sleeve members are combinable by inserting pins 35 disposed on the first outer sleeve member 33A into matching cavities 47 disposed on the second outer sleeve member 33B. The inner sleeve members are combinable by inserting pins 37 disposed on the first inner sleeve member 34A into matching cavities 52 disposed on the second inner sleeve member 34B. The base sleeve members 23A and 23B are attached to the respective inner sleeve members 34A and 34B; thus by combining the inner sleeve members brings about the joining of the two base sleeve members 23A and 23B as well. Likewise, a stopper ring having a first member and a second member may be attached to the respective base sleeve members to form an integral stopper ring when joined together.

The outer sleeve and the shield are made of materials sufficiently resilient to withstand the weights of vehicles. The preferred material of construction is plastic; however metal and wood also fall within the scope of the present invention.

It should be understood, of course, that the foregoing relates to exemplary embodiments of the invention and that modifications may be made without departing from the spirit and scope of the invention.

I claim:

1. A shield assembly for garden hose connecting ends, said connecting ends containing a threaded male adaptor, said threaded male adaptor being joined with a ferrule member and a hose connector end portion, said connecting ends optionally comprising a female threaded member configured to being joined with said threaded male adaptor, said shield assembly comprising:
an inner sleeve adapted for encasing the hose connector end portion, said inner sleeve being attached to the hose connector end portion in a fixed and immobile position, said inner sleeve having a circular bore and a multisided outer wall surface, said outer wall surface containing at least four sides;
an outer sleeve containing a sliding portion adapted for slidingly threading over the inner sleeve and an enlarged portion adapted to cover the hose connecting end, said sliding portion having a multisided inner wall surface, said multisided inner wall surface being adapted to match and fit over the multisided outer wall surface of the inner sleeve; and
a mechanism for preventing an unintentional longitudinal sliding of the outer sleeve on the inner sleeve and for securing the outer sleeve in predetermined discreet positions.

2. The shield assembly of claim 1, wherein the multisided outer wall surface of the inner sleeve contains four sides of equal length, said fours sides defining a square shape.

3. The shield assembly of claim 1, wherein the multisided outer wall surface of the inner sleeve contains six sides of equal length, said six sides defining a hexagonal shape.

4. The shield assembly of claim 1, wherein the multisided outer wall surface of the inner sleeve contains eight sides of equal length, said eight sides defining an octagonal shape.

5. The shield assembly of claim 1 further comprising a cylindrical base sleeve threaded over the connector ends portion of the hose, said base sleeve being attached to the hose connector end portion in an immobile position, said inner sleeve being adapted for encasing the base sleeve, said inner sleeve being attached to the base sleeve in a fixed and immobile position, said base sleeve having a front end and a rear end, said rear end containing a stopper ring.

6. The shield assembly of claim 1, wherein the mechanism for preventing the unintentional longitudinal sliding of the outer sleeve along the inner sleeve and for securing the outer sleeve in predetermined discreet positions comprises:
at least two channels disposed radially in the inner wall of the outer sleeve;
at least two depressions disposed longitudinally in the outer surface of each of at least two sides of the inner sleeve;
a coiled spring placed inside each depression; and
a protruding object placed over each coiled spring, said protruding object being configured for being contained inside the depression and to compress the coiled spring, said protruding object also being configured to protrude outside the depression and exert pressure onto the inner wall surface of the outer sleeve, said protruding object being configured for wedging inside each channel in the inner wall of the outer sleeve in such a manner that a force exerted longitudinally would be required to move the protrusion out of the channel.

7. The shield assembly of claim 6, wherein the protruding object has a spherical shape.

8. The shield assembly of claim 6 wherein the outer wall of the inner sleeve comprises four channels.

9. The shield assembly of claim 1, wherein the mechanism for preventing an unintentional longitudinal sliding of the outer sleeve along the inner sleeve and for securing the outer sleeve in predetermined discreet positions comprises:
at least two channels disposed radially in the outer wall of the inner sleeve;
at least two channels disposed radially in the inner wall of the outer sleeve;
a compression ring placed inside each channel, said each compression ring being configured to protrude outside the channel and exert pressure onto the inner wall surface of the outer sleeve.

10. The shield assembly of claim 9, further comprising at least two channels disposed radially in the inner wall of the outer sleeve, said each compression ring being configured for wedging inside each channel in the inner wall of the outer sleeve in such a manner that a force exerted longitudinally would be required to move the compression ring out of the channel.

11. The shield assembly of claim 9 wherein the outer wall of the inner sleeve comprises four channels.

12. The shield assembly of claim 9 wherein the inner wall of the outer sleeve comprises four channels.

13. The shield assembly of claim 5, wherein the inner sleeve comprises a first inner sleeve member and a second inner sleeve member, said first inner sleeve member being configured for interlocking with said second inner sleeve member over the hose connector end portion in a manner as to form an integral inner sleeve, said interlocking being accomplished by inserting two interlocking pins disposed on the first inner sleeve member into corresponding cavities disposed in the second inner sleeve member.

14. The shield assembly of claim 13, wherein the outer sleeve comprises a first outer sleeve member and a second sleeve member, said first outer sleeve member being configured for interlocking with said second outer sleeve member over the inner sleeve in a manner as to form an integral outer sleeve, said interlocking being accomplished by inserting two interlocking pins disposed on the first outer sleeve member into corresponding cavities disposed in the second outer sleeve member.

15. The shield assembly of claim 14, wherein the base sleeve comprises a first base sleeve member and a second base sleeve member, said first base sleeve member containing a first stopper ring member at an end portion of the first base sleeve member, said second base sleeve member containing a second stopper ring member at an end portion of the second base sleeve member, said first base sleeve member being configured for attaching to the second base sleeve member over the hose connector end portion to form an integral base sleeve, said first stopper ring member being configured for attaching to the second stopper ring member over the hose connector end portion to form an integral stopper ring, said first inner sleeve member being configured for interlocking with said second inner sleeve member over the integral base sleeve.

16. A shield assembly for garden hose connecting ends, said connecting ends containing a threaded male adaptor, said threaded male adaptor being joined with a ferrule member and a hose connector end portion, said connecting ends optionally comprising a female threaded member configured to being joined with said threaded male adaptor, said shield assembly comprising:
an inner sleeve adapted for encasing the hose connector end portion, said base sleeve being attached to the hose connector end portion in a fixed and immobile position, said inner sleeve having a circular bore, a front end and a circular outer wall surface;
an outer sleeve containing a sliding portion adapted for slidingly threading over the inner sleeve and an enlarged portion adapted to cover the hose connecting end, said sliding portion having a substantially circular inner wall surface, said circular inner wall surface being adapted to match and fit over the circular outer wall surface of the inner sleeve;
a mechanism for affixing the outer sleeve in an engage position; and
a mechanism for affixing the outer sleeve in a disengage position.

17. The shield assembly of claim 16 wherein the mechanism for affixing the outer sleeve in an engaged position comprises:
at least two longitudinal channels disposed on the outer surface of the inner sleeve, said each longitudinal channel having a forward end and a rear portion;
a first branched channel member being in communication with the forward end of each longitudinal channel, said first branched channel member having at least one radial branch and at least one longitudinal branch; and
a tab corresponding with each longitudinal channel and corresponding first branched channel member, said tab being attached to the inner wall surface of the outer sleeve at one end, said tab having a second end being adapted for fitting into said longitudinal channel and corresponding first branched channel member, said tab second end also being adapted for traversing said longitudinal channel and corresponding first branched channel member.

18. The shield assembly of claim 17, wherein the mechanism for affixing the outer sleeve in a disengage position comprises:
a second branched channel member being in communication with the rear portion of each longitudinal channel, said second branched channel member having at least one radial branch and at least one longitudinal branch;
said second end of the tab also being adapted for fitting into the longitudinal channel and corresponding second branched channel member, said second end of the tab also being adapted for traversing said longitudinal channel and corresponding second branched channel member.

19. The shield assembly of claim 17, further comprising a cylindrical base sleeve threaded over the hose connector end portion, said base sleeve being attached to the hose connector end portion in an immobile position, said inner sleeve being adapted for encasing the base sleeve, said inner sleeve being attached to said base sleeve in a fixed and immobile position, said base sleeve having a front end and a rear end, said rear end containing a stopper ring.

20. The shield assembly of claim 17, further comprising:
a compressible spring coil disposed between a ring member of the ferrule and the front end of the inner sleeve; and
at least two tabs wherein each of said tabs has a first end attached to the inner wall surface of the outer sleeve and a second end being configured to engage and compress the spring coil when the outer sleeve is retracted to the disengage position.

21. The shield assembly of claim 18 wherein four longitudinal channels and corresponding first branch channel members and second branched channel members are disposed on the outer surface of the inner sleeve.
